(19) United States
(12) Patent Application Publication
(10) Pub. No.: US 2004/0202751 A1
(43) Pub. Date: Oct. 14, 2004

(54) Illuminated beverage-holding device

(76) Inventors: Christopher B. McKay, Carmel, CA (US); Daniel McKay, Carmel, CA (US); David Silverglate, Santa Cruz, CA (US)

Correspondence Address: KOLISCH, HARTWELL, DICKINSON,, McCORMACK & HEUSER, Suite 200, 520 S.W. Yamhill Street, Portland, OR, 97204, US

(21) Appl. No.: 10/037,471

(22) Filed: Dec. 21, 2001

Related U.S. Application Data
(60) Provisional application No. 60/258,116, filed on Dec. 22, 2000.

(51) Int. Cl. A23B 4/00

(52) U.S. Cl. 426/112

(57) ABSTRACT

An illuminated beverage-holding device. The device includes a body that is at least partially formed from a translucent or transparent material. The device includes a light-emitting assembly that is adapted to selectively generate light that passes through the body to illuminate the device. In some embodiments, the device includes a light-directing structure generally between the light-emitting assembly and a beverage-holding portion of the device.

### RELATED APPLICATION

This application claims priority to co-pending U.S. Provisional Patent Application Serial No. 60/258,116, which was filed on Dec. 22, 2000 and the complete disclosure of which is hereby incorporated by reference for all purposes.

### FIELD OF THE INVENTION

The present invention relates generally to beverage containers, and more particularly to illuminated beverage-holding devices.

### BACKGROUND AND SUMMARY OF THE INVENTION

Beverage-holding devices are devices that hold beverages for drinking. Examples of beverage-holding devices include cups, mugs, glasses, wine goblets, champagne flutes, dessert cups, shot glasses, martini glasses, and the like. Conventional beverage-holding devices may vary in size and shape, but typically are merely carriers for the beverages contained within.

The present invention provides an illuminated beverage-holding device. The device includes a body that is at least partially formed from a translucent or transparent material. The device includes a light-emitting assembly that is adapted to selectively generate light, which passes through the body to illuminate the device. In some embodiments, the device includes a light-directing structure generally between the light-emitting assembly and a beverage-holding portion of the device.

### BRIEF DESCRIPTION OF THE DRAWINGS

FIG. 1 is an isometric view of an illuminated beverage-holding device according to the present invention, with the beverage-holding device taking the form of a stemmed beverage-holding device.

FIG. 2 is a top plan view of the device of FIG. 1.

FIG. 3 is a schematic cross-sectional view of the device of FIG. 1.

FIG. 4 is a top plan view of the device of FIG. 3.

FIG. 5 is cross-sectional view of the base of the device of FIG. 1.

FIG. 6 is a bottom plan view of the base of FIG. 1.

FIG. 7 is a circuit diagram of an illustrative light-emitting assembly for use in illuminated beverage-holding devices according to the present invention.

FIG. 8 is a circuit diagram of another light-emitting assembly according to the present invention.

FIG. 9 is a schematic cross-sectional view of another illuminated beverage-holding device constructed according to the present invention.

FIG. 10 is a fragmentary cross-sectional detail of the light-directing structure shown in the device of FIG. 9.

FIG. 11 is a fragmentary cross-sectional detail showing another light-directing structure constructed according to the present invention.

FIG. 12 is a fragmentary cross-sectional detail showing another light-directing structure constructed according to the present invention.

FIG. 13 is a fragmentary cross-sectional detail showing another light-directing structure constructed according to the present invention.

FIG. 14 is a fragmentary cross-sectional detail showing another light-directing structure constructed according to the present invention.

FIG. 15 is an exploded cross-sectional view of a stemmed beverage-holding device according to the present invention.

FIG. 16 is a fragmentary detail of the stem portion of FIG. 15.

FIG. 17 is a top plan view of the base of FIG. 15.

FIG. 18 is a fragmentary cross-sectional view of the stem portion of FIG. 16 and the base of FIG. 17.

FIG. 19 is a fragmentary cross-sectional view showing variations of the base and the stem portion of FIG. 18.

FIG. 20 is a fragmentary cross-sectional view showing variations of the stem portion of FIG. 15.

FIG. 21 is a fragmentary cross-sectional view showing further variations of the stem portion of FIG. 15.

FIG. 22 is a fragmentary cross-sectional view showing another variation of the stem portion of FIG. 15.

FIG. 23 is a schematic cross-sectional view of the illuminated beverage-holding device according to the present invention.

FIG. 24 is a schematic cross-sectional view of the illuminated beverage-holding device according to the present invention, with the beverage-holding device taking the form of a stemless beverage-holding device.

FIG. 25 is a schematic cross-sectional view of the illuminated beverage-serving device according to the present invention, with the beverage-serving device taking the form of a tray.

### DETAILED DESCRIPTION AND BEST MODE OF THE INVENTION

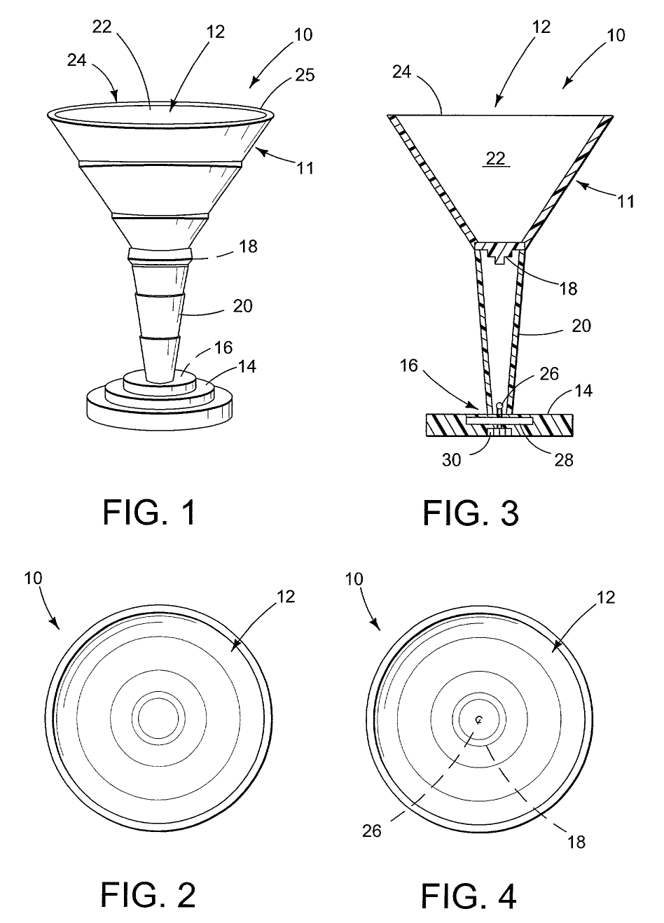

Illuminated beverage devices constructed according to the present invention are indicated generally at 10 in FIGS. 1-4. Devices 10 each include a body 11 with a beverage-holding portion 12 and a base 14. Each device further includes a light-emitting assembly 16, and in the embodiment illustrated in FIGS. 1 and 3, a light-directing structure 18. In the embodiments shown in FIGS. 1 and 3, devices 10 further include a stem portion 20; however, it is within the scope of the invention that device 10 may be stemless or formed without a stem portion. In the illustrated embodiments, devices 10 take the form of a martini, or cocktail, glass. It should be understood, however, that the shape and size of device 10 may vary, such as to take the form of, or generally resemble, a wide variety of glassware, such as mugs, drinking glasses, shot glasses, wine goblets, champagne flutes, beer steins, etc.

Beverage-holding portion 12 is adapted to receive a volume of a potable beverage. Portion 12 includes a cavity 22 with an opening 24 through which the beverage is added to the cavity or removed therefrom, such as by drinking. In the illustrated embodiment shown in FIG. 1, opening 24 is defined by arm, or lip, 25 from which a user drinks. Base 14 supports the beverage-holding portion upon a surface, either directly or via an intermediary support such as stem portion 20 or another suitable supporting structure extending between the base and the beverage-holding portion.

At least a portion of body 11 is formed from a light-transmitting, or light-permeable, material that is positioned to receive and be at least partially illuminated by light produced by assembly 16. By this it is meant a material through which visible light may pass, thereby at least partially illuminating the device. Examples of suitable materials include transparent and translucent materials, as well as transparent materials that have been tinted or otherwise colored, or which include translucent or opaque regions. Preferably, at least a portion of the beverage-holding portion and/or stem portion is formed from a light-transmitting, or light-permeable, material. By this it is meant a material through which visual light may pass, thereby at least partially illuminating the device. Non-exclusive examples of suitable materials include many plastics, glasses, and acrylics.

Light-emitting assembly 16 is adapted to emit light responsive to one or more user-inputs or other triggering events. As schematically illustrated in FIG. 3, light-emitting assembly 16 includes one or more lights, or light-emitting devices, 26, a power source 28, and one or more actuators 30 that are adapted to complete an electrical circuit between the one or more lights and the power source. Lights 26 may be any suitable light-emitting devices. Examples of suitable light-emitting devices include LEDs, fiber optic lights, halogen lights, incandescent light bulbs, etc. Conventional high-intensity LEDs have proven effective, such as a 3000 mcd LED. Power source 28 includes any suitable device for providing power to the one or more lights 26. Typically, the power source will include one or more batteries 31. Examples of suitable batteries include watch batteries, camera batteries, AA or AAA batteries, rechargeable batteries and the like. In experiments, a 3-volt lithium battery has performed well, although others may be used and are within the scope of the invention.

Actuator 30 is any suitable switch that when actuated completes (or alternatively opens) an electrical circuit between the power source and the one or more light-emitting devices to cause the device(s) to emit light. Actuator 30 typically includes a sensor or a user-manipulable element that is used to selectively actuate or deactuate the actuator, and thereby the light-emitting assembly. Examples of suitable actuators are user-manipulable switches that complete the electrical circuit between the power source and the one or more light-emitting devices responsive to user-applied force to the switch. Examples of suitable switches are two-position switches, which rest in a selected position until user-applied forces applied to the user-manipulable element of the switch toggle the switch to another position, and momentary switches, which automatically return to a resting position upon release of a user-applied force. The particular construction of the user-manipulable switches may vary, and any suitable user-manipulable switch structure may be used.

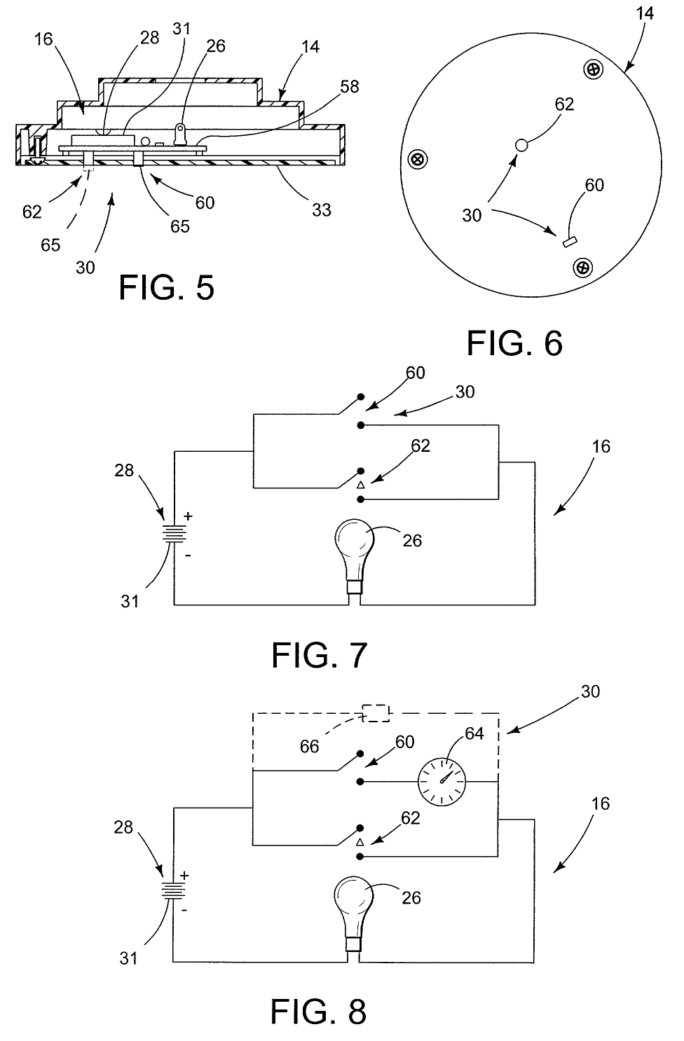

For example, in FIG. 5, an example of a light-emitting assembly 16 is shown that includes a circuit board 58 on which a light 26, a power source 28 in the form of a battery 31, and a pair of actuators 30 are mounted. In FIGS. 5 and 6, two illustrative actuators 30 are shown and generally indicated at 60 and 62. At 60 an example of an actuator in the form of a two-position switch is shown, and at 62 an example of an actuator in the form of a momentary switch is shown. The two-position switch enables the light-emitting assembly to be actuated until the switch is returned to its “off” position, in which the electrical circuit between the light-emitting assembly's power source and the light-emitting device is open. The momentary switch enables the light-emitting assembly to be temporarily actuated until the user-manipulable portion of the switch is released by the user.

FIGS. 7 and 8 schematically depict examples of suitable circuit diagrams for the light-emitting assembly shown in FIG. 5. In FIG. 8, the light-emitting assembly is shown further including a timer 64 that selectively opens the circuit between the power source and light-emitting device after the light-emitting assembly has been actuated for a predetermined, or preselected, period of time, such as five seconds, thirty seconds, two minutes, or any other predetermined or preselected time period upon expiration of which the timer is configured to open the circuit. Timer 64 may alternatively be configured to close the circuit after the light-emitting assembly has not been actuated for a predetermined time period.

Also shown in FIG. 5 in dashed lines is a momentary switch that is biased to extend downward beyond the lower edge 33 of the base so that setting device 10 on a surface will actuate the switch and thereby actuate light-emitting assembly 16. As a variation on this configuration, switch 60 may be used to either actuate assembly 16 or to enable actuation of assembly 16, and then switch 62 may be used to de-actuate or actuate assembly 16, respectively.

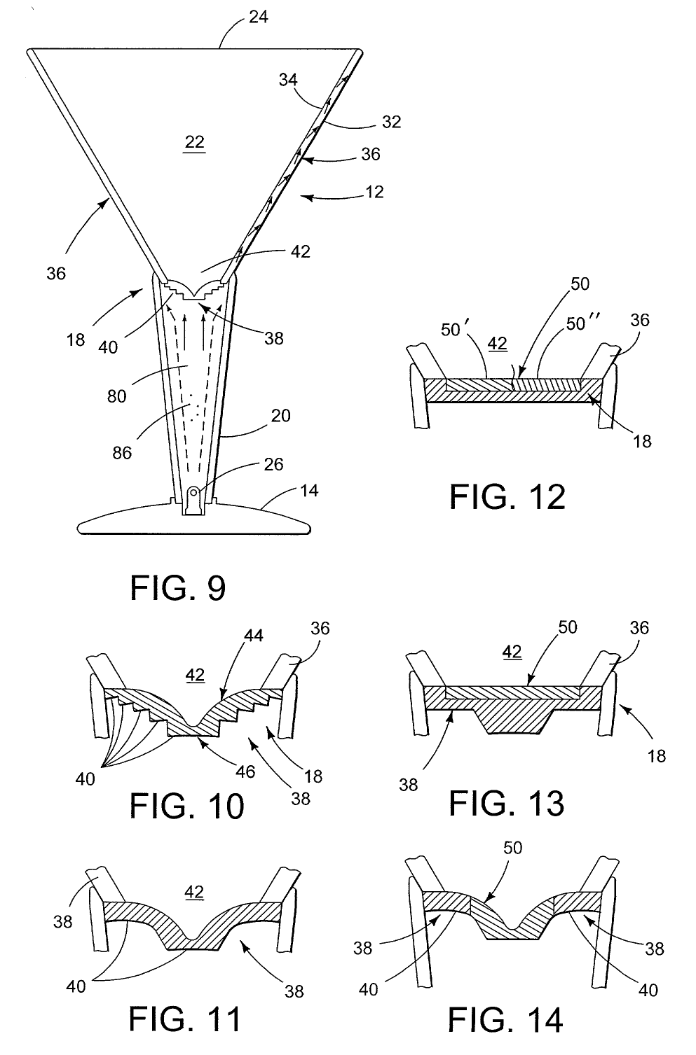

It should be understood that only a single switch or other actuator may be used. Similarly, actuators 30 according to the present invention may include a sensor or other actuating device other than the user-manipulable elements 65 shown in FIG. 5. Examples of suitable sensors include liquid sensors adapted to complete the circuit upon detection of, or the lack of detection of, fluid in the cavity 22 of beverage-holding portion 12, temperature sensors adapted to complete the circuit upon detection of a temperature within or outside of a predetermined temperature range or above or below a predetermined threshold temperature, pressure sensors adapted to complete the circuit upon detection of a predetermined amount of pressure on a portion of device 10, such as base 14, stem portion 20, exterior 32 or interior 34 (as shown in FIG. 9) of the beverage-holding portion, and light sensors adapted to detect the amount of light in the environment surrounding beverage-holding device 10 and to complete the circuit should the light exceed a predetermined value. An actuator 30 utilizing one or more of the above sensors is schematically illustrated in dashed lines in FIG. 8 at 66, and it should be understood that such an actuator may be used alone or in combination with one or more other actuators 30. Similarly, the above-described sensors may alternatively be configured to actuate the light-emitting assembly upon the absence of detection of any one or more of the above-described triggering, or actuating, events. For example, upon detection of the absence of liquid in beverage-holding portion 22, the light-emitting assembly may be actuated.

Light-directing structure 18 is adapted to soften the light entering the lower portion 42 of cavity 22 in the beverage-holding portion and to direct at least a substantial portion of the light through and along the sides 36 of the beverage-holding device, as opposed to through the cavity 22 in the beverage-holding portion. The path of the light through the sides of the device is schematically illustrated with arrows in FIG. 9. As schematically illustrated in FIG. 9, although the actuated light-emitting device 26 is directed beneath the center of the beverage-holding portion, at least a substantial portion of the light is directed outwardly and along the sides 36 of the beverage-holding portion instead of directed through lower portion 42. It should be understood that some of the emitted light may still pass through portion 42. However, in embodiments of device 10 that include a light-directing structure 18, the amount of light passing through portion 42 should be substantially reduced from the comparable amount of light from assembly 16 that would pass through portion 42 if structure 18 were not present. Preferably at least 50%, if not at least 75% or more of the emitted light that otherwise would pass through portion 42 is focused, blocked or otherwise directed so that it does not pass through portion 42.

An example of a suitable light-directing structure 18 is a lens assembly 38, such as shown in FIG. 9. Assembly 38 includes one or more lenses 40 oriented or shaped to direct the light primarily along the sides of the beverage-holding device and optionally to soften the light entering the lower portion 42 of cavity 22. Lens assembly 38 may also be described as breaking up the light emitted by light-emitting device 26 and directing the light along the sides of the beverage-holding portion or the beverage-holding device instead of directly through the beverage-holding portion. It should be understood that these portions may be completely formed of these translucent or transparent materials. However, these portions may also include opaque regions or structures as well.

In FIG. 10, an example of a lens assembly 38 is shown that includes a plurality of lenses, or lens surfaces, 40. In the depicted embodiment, assembly 38 includes an arcuate upper portion 44, and a lower portion 46 that includes a plurality of radially spaced-apart lens surfaces 40 that are adapted to direct light emitted from light-emitting assembly 16 generally along sides 36 of the beverage-holding portion. It is within the scope of the invention that the lens assembly may be formed from a single integral component or from two or more separate components that are either separately positioned within device 10 or joined together after formation. Similarly, assembly 38 may include only a single lens or lens surface and it may include other configurations of physically spaced-apart lenses. Another example of a suitable lens assembly 38 is shown in FIG. 11 and includes a lesser number of lenses, or lens surfaces, 40 than the previously illustrated example.

It should be understood that the light-directing properties of the upper and/or lower portions of lens assembly 38 may be implemented using a variety of different angular orientations and distances. It should also be understood that the precise shape and orientation of lens assembly 38 or other light-directing structure 18 will tend to vary depending upon such factors as the shape of the beverage-holding device, and the size, type, number, position and orientation of light-emitting devices 26 used in light-emitting assembly 16. Similarly, the light-directing properties of assembly 38 may be imparted from any one or more regions of the assembly, such as at least one of the upper portion, lower portion, and an internal central portion of the assembly.

Another example of a suitable light-directing structure 18 is a shade element that deflects or otherwise obstructs the path of the light to prevent at least a substantial portion of the light from passing through the lower portion of cavity 22. An example of a shade portion is shown in FIG. 12 and generally indicated at 50. Shade portion 50 may be formed from a reflective or opaque material that reflects or otherwise blocks light emitted from assembly 16 and thereby prevents this light from passing through the shade portion and into cavity 22. An example of such a shade portion is indicated at 50′. However, it is also within the scope of the invention that shade portion 50 is formed from an at least partially translucent material, which is generally indicated at 50″, that blocks at least a substantial portion of the emitted light. As a further variation, shade portion 50 may include both opaque or reflective regions as well as translucent regions.

In FIG. 13, another example of a light-directing structure 18 is shown. In the illustrated embodiment, structure 18 includes both a lens assembly 38 and a shade portion 50. Yet another illustrative example of such a light-directing structure is shown in FIG. 14 to illustrate that assembly 38 and portion 50 may have a variety of configurations and relative positions without departing from the scope of the invention.

It is also within the scope of the present invention that device 10 may be formed without light-directing structure 18. However, this structure is preferred because it primarily directs the light emitted by light-emitting device(s) 26 to illuminate the glass instead of primarily directing the light through the beverage and thereby illuminating the user's face when the user drinks from device 10. In other words, light-directing structure 18 prevents or reduces the “colored nose” look that would otherwise result without beverage-holding device 10 including this structure.

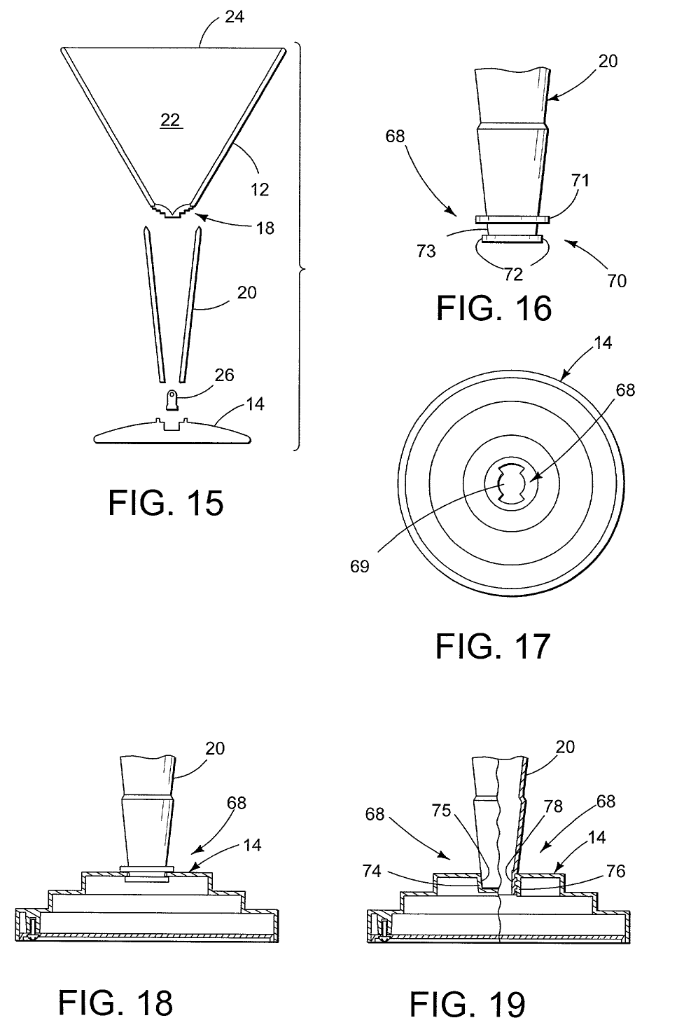

Device 10 may be manufactured in any suitable number of components. For example, the portion of the device containing the light-emitting assembly 16 may be selectively detachable from the rest of the device so that the rest of the device may be washed without wetting the light-emitting assembly. For example, when the light-emitting assembly is housed in the base 14 of the device, as shown in FIG. 15, base 14 may be selectively detachable from stem portion 20 and the rest of the device. Alternatively, assembly 16 may be housed in stem portion 20, in which case it may be desirable for the stem portion to be selectively detachable from the beverage-holding portion and/or base 14. Additionally or alternatively, the light-emitting assembly may be sealed within a waterproof enclosure. As used herein, “selectively detachable” is meant to refer to structures that are configured to be repeatedly coupled together and released from engagement to configure the structures between assembled and disassembled configurations.

When base 14 is selectively detachable from stem portion 20, these portions preferably include a coupling structure 68 that enables the portions to be repeatably attached and detached from each other. Any suitable coupling structure may be used. An example of a suitable coupling structure is shown in FIGS. 16 and 17. As shown, base 14 includes a keyed opening 69 through which a key portion 70 of stem portion 20 may be selectively inserted. Rotation of the stem portion relative to the base causes the key portion of the stem portion to be retained within the base, as shown in FIG. 18. More specifically, the stem portion includes ears 72 that are shaped to fit through opening 69 in a first rotational orientation relative to the base, but not to fit through the opening when the stem portion and base have been rotated from this orientation.

Also shown in FIG. 16 is a retainer 71 above ears 72. Retainer 71 and ears 72 collectively define a neck region 73 into which a portion of the base is received when the stem portion and base are coupled together. Neck region 73 is sized to produce a sturdy support of stem portion 20, and the rest of the beverage-holding device, when the stem portion is coupled to the base.

Examples of other suitable coupling structures include a friction fit between the base and stem portion and a threaded engagement between the portions. For purposes of illustration, an example of a coupling structure 68 in the form of portions 74 and 75 that are selectively secured together through a friction fit is shown on the left side of FIG. 19, and a coupling structure in the form of threaded portions 76 and 78 that are configured to be selectively secured together by a threaded engagement is shown on the right side of FIG. 19. When device 10 includes a light-emitting assembly that is selectively detachable from a portion of the device that includes beverage-holding device 10, the coupling structure should be configured so that it does not prevent the transmission of light from assembly 16 to the stem portion 20 and/or sides 36 of the device.

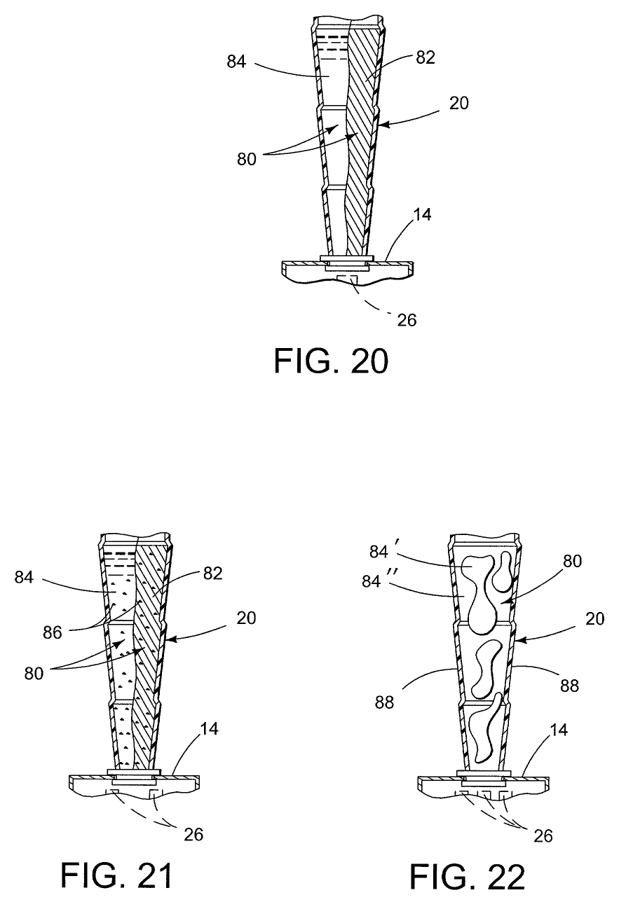

In embodiments of device 10 that include a stem portion 20 separating light(s) 26 and beverage-holding portion 12, the stem portion may have a variety of configurations, including configurations that are shorter, longer, wider and/or narrower than the exemplary configuration shown in the previously described figures. Stem portion 20 may be hollow, and thereby include an internal cavity 80 that is filled with air or another suitable gas, such as graphically illustrated with reference back to FIG. 9. The cavity may alternatively be filled with a solid material, such as material 82, through which light emitted by assembly 16 may pass. As a further alternative, the stem portion may be formed completely of a solid material 82 through which light emitted by assembly 16 may pass. An example of such a configuration is shown on the right side of FIG. 20. In such a configuration, the solid material may be the same material that is used to form the rest of stem portion 20 or body 11. However, it may also be formed from a different material, including those discussed above with respect to the light-permeable portion of body 11.

As another example, cavity 80 may be partially or completely filled with one or more light-permeable liquids 84, such as shown on the left side of FIG. 20. As still another example, stem portion 20 may include a plurality of small solid particles 86, such as glitter, small ornamental objects, particulate, etc., that are dispersed or dispersable in cavity 80 along with a gas, liquid, or solid component that at least substantially fills the cavity. Examples of this configuration are somewhat schematically illustrated in dashed lines in FIG. 9 and on the right and left sides of FIG. 21. As yet another example, cavity 80 may include two or more immiscible liquids, such as shown in FIG. 22 and indicated at 84′ and 84″.

As discussed, the shape, size and configuration of beverage-holding devices 10 according to the present invention may vary. For example, the shape and configuration of light-directing structure 18, if present in a particular embodiment, and the number of light-emitting devices 26 may vary within the scope of the invention, such as with changes in the shape and size of the beverage-holding device. For example, beverage-holding devices that include relatively narrow stem portions will typically, but not necessarily, include a single light-emitting device 26, while beverage-holding devices that do not have a stem portion or which have a very wide stem portion will tend to, but not necessarily, include more than one light-emitting device 26. To graphically illustrate this point, FIGS. 20-22 demonstrate portions of devices 10 that include a single light-emitting device 26 and a plurality of light-emitting devices 26. When more than one light-emitting device 26 is used, they may be positioned generally beneath portion 42 and/or generally beneath the sides 88 of stem portion 20 and/or the sides 36 of beverage-holding portion 12.

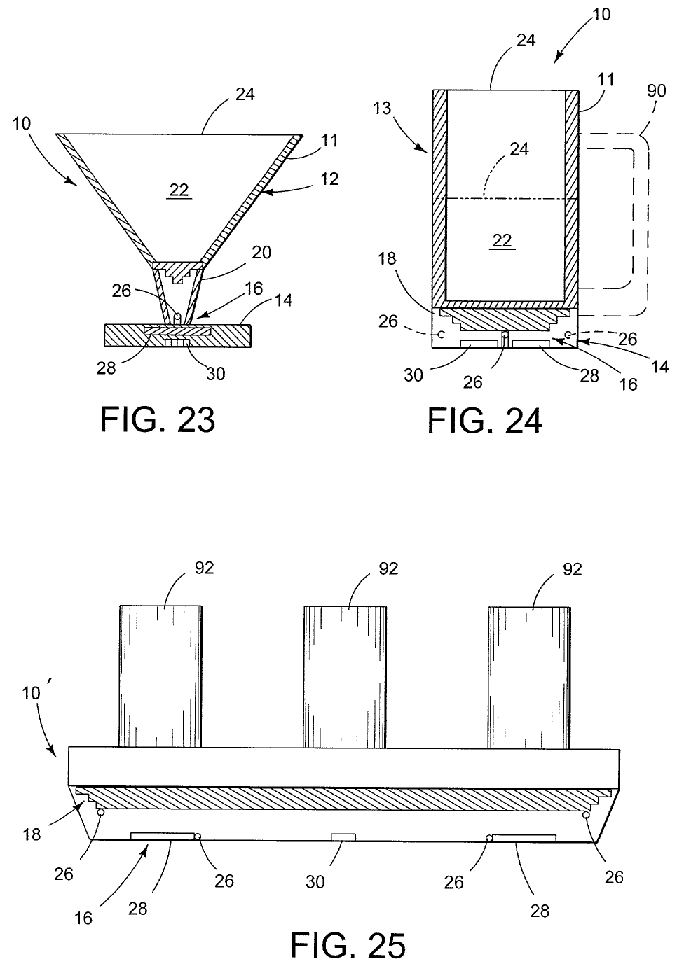

As also discussed, beverage-holding portion 12 may have other shapes and relative volumes, such as the shapes and/or volumes of a variety of conventional glassware. Similarly, the shape and relative size of stem portion 20 may vary, including embodiments of device 10 that do not include a stem portion. To graphically illustrate this point, an illustrative example of a device 10 that includes a shorter stem portion 20 is shown in FIG. 23. Examples of glassware that may have such a stem portion include some dessert glasses and brandy snifters.

An example of a device 10 that does not include a stem portion is shown in FIG. 24. Examples of glassware that does not typically include a stem portion include mugs, cups, old-fashioned glasses, and highball glasses. In FIG. 24, a handle 90 is shown in dashed lines to illustrate graphically that beverage-holding devices 10 according to the present invention may include mugs, tumblers, cups and the like that include handles. In dash-dot lines in FIG. 24, an embodiment of a stemless beverage-holding device having a comparatively shorter beverage-holding portion is shown.

In FIG. 25, the previously described light-emitting assembly and light-directing structure is shown implemented on a beverage-serving device, namely a tray, which is generally indicated at 10′ and upon which are shown a plurality of beverage holding devices 92. A similar construction may be used on other beverage- and food-serving devices, such as plates, bowls and the like. It should be understood that the devices shown in FIGS. 22-24 may include any of the elements, subelements and variations described, illustrated and/or incorporated herein.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower or equal in scope to the original claims, are also regarded as included within the subject matter of the inventions of the present disclosure.

We claim:

1. A beverage-holding device, comprising:
a body having a beverage-holding portion adapted to receive a beverage and having an opening from which a user may drink the beverage, and a base adapted to support the beverage-holding portion on a surface; and
a light-emitting assembly housed at least partially within the body and including at least one light-emitting device and at least one actuator, wherein upon actuation, the light-emitting assembly is adapted to emit light generally toward the beverage-holding portion, and further wherein at least a portion of the body is formed from a light-permeable material through which the emitted light may pass to illuminate at least a portion of the device.

2. The device of claim 1, wherein the beverage-holding portion includes sides that are at least substantially formed from a light-permeable material, and further wherein the light-emitting assembly is adapted to emit light that passes through the sides.

3. The device of claim 1, wherein the device further includes a light-directing structure adapted to redirect at least a substantial portion of the emitted light that would otherwise pass through a lower portion of the beverage-holding portion to reduce the amount of emitted light that passes through the lower portion.

4. The device of claim 3, wherein the light-directing structure is adapted to reduce by at least 50% the amount of the emitted light that passes through the lower portion.

5. The device of claim 3, wherein the light-directing structure is adapted to reduce by at least 75% the amount of the emitted light that passes through the lower portion.

6. The device of claim 3, wherein the light-directing structure is adapted to prevent the emitted light from passing through the lower portion.

7. The device of claim 3, wherein the beverage-holding portion includes sides and the light-directing structure includes a lens assembly adapted to focus the emitted light toward the sides of the beverage-holding portion.

8. The device of claim 7, wherein the lens assembly includes a plurality of lens surfaces.

9. The device of claim 7, wherein the light-directing structure further includes a shade through which at least a substantial portion of the emitted light cannot pass.

10. The device of claim 3, wherein the light-directing structure includes a shade through which at least a substantial portion of the emitted light cannot pass.

11. The device of claim 10, wherein the shade includes an opaque region.

12. The device of claim 10, wherein the shade includes a reflective region.

13. The device of claim 1, wherein the beverage-holding portion is at least substantially formed from a light-permeable material.

14. The device of claim 1, wherein the beverage-holding portion is completely formed from a light-permeable material.

15. The device of claim 1, wherein the body further includes a stem portion extending between the base and the beverage-holding portion.

16. The device of claim 15, wherein the stem portion is at least substantially formed from a light-permeable material through which the emitted light may pass.

17. The device of claim 16, wherein at least one light-emitting device is housed in the base and configured to emit light generally through the stem portion and generally toward the beverage-holding portion.

18. The device of claim 16, wherein the stem portion includes a lower region in which at least one light-emitting device is positioned and configured to emit light generally through the stem portion and generally toward the beverage-holding portion.

19. The device of claim 15, wherein the stem portion defines an internal cavity containing a fluid.

20. The device of claim 19, wherein the fluid is a gas.

21. The device of claim 19, wherein the fluid includes a liquid.

22. The device of claim 21, wherein cavity further includes a plurality of solid particles.

23. The device of claim 21, wherein the fluid includes at least two immiscible liquids.

24. The device of claim 1, wherein the body is a stemless body.

25. The device of claim 1, wherein the at least one actuator includes a switch having a user-manipulable element.

26. The device of claim 25, wherein the switch is a two-position switch.

27. The device of claim 25, wherein the switch is a momentary switch.

28. The device of claim 25, wherein the actuator further includes a timer adapted to reverse the state of actuation of the light-emitting assembly a predetermined time period after actuation of the light-emitting assembly.

29. The device of claim 1, wherein the light-emitting assembly further includes a timer adapted to reverse the state of actuation of the light-emitting assembly a predetermined time period after actuation of the light-emitting assembly.

30. The device of claim 1, wherein the at least one actuator includes a switch having a sensor adapted to actuate the light-emitting assembly upon detection of at least one of a predetermined pressure, a predetermined temperature, a predetermined amount of light and a predetermined amount of liquid.

31. The device of claim 1, wherein the at least one actuator includes a switch having a sensor adapted to actuate the light-emitting assembly upon detection of the absence of at least one of a predetermined pressure, a predetermined temperature, a predetermined amount of light and a predetermined amount of liquid.

32. The device of claim 1, wherein the base is adapted to be selectively removed from and reattached to the rest of the body.

33. A beverage-holding device, comprising:
a body having a beverage-holding portion adapted to receive a beverage and having an opening from which a user may drink the beverage, and a base adapted to support the beverage-holding portion on a surface; and
a light-emitting assembly housed at least partially within the base and including at least one light-emitting device and at least one actuator, wherein upon actuation, the light-emitting assembly is adapted to emit light generally toward the beverage-holding portion, and further wherein at least a portion of the body is formed from a light-permeable material through which the emitted light may pass to illuminate at least a portion of the device.

34. The device of claim 33, wherein the light-emitting assembly includes at least one battery adapted to power the at least one light-emitting device.

35. The device of claim 33, wherein the light-emitting assembly includes a plurality of light-emitting devices.

36. The device of claim 33, wherein the beverage-holding portion includes sides and the light-emitting assembly includes at least one light-emitting device generally beneath the sides.

37. The device of claim 36, wherein the beverage-holding portion includes at least two light-emitting devices generally beneath the sides.

38. The device of claim 33, wherein the light-emitting assembly includes an actuator in the form of a switch having a user-manipulable element that is adapted to actuate the light-emitting assembly upon receipt of user-applied forces to the user-manipulable element.

39. The device of claim 38, wherein the user-manipulable element extends generally away from the beverage-holding portion.

40. The device of claim 33, wherein the light-emitting assembly includes a timer adapted to reverse the state of actuation of the light-emitting assembly a predetermined time period after actuation of the light-emitting assembly.

41. The device of claim 33, wherein the at least one actuator includes a switch having a sensor adapted to actuate the light-emitting assembly upon detection of at least one of a predetermined pressure, a predetermined temperature, a predetermined amount of light and a predetermined amount of liquid.

42. The device of claim 33, wherein the at least one actuator includes a switch having a sensor adapted to actuate the light-emitting assembly upon detection of the absence of at least one of a predetermined pressure, a predetermined temperature, a predetermined amount of light and a predetermined amount of liquid.

43. The device of claim 33, wherein the base is adapted to be selectively removed from and reattached to the beverage-holding portion.

44. The device of claim 43, wherein the device includes a coupling structure adapted to selectively couple the base to the beverage-holding portion.

45. The device of claim 44, wherein the coupling structure is adapted to selectively couple the base to the beverage-holding portion through a friction fit.

46. The device of claim 44, wherein the coupling structure is adapted to selectively couple the base to the beverage-holding portion through a threaded engagement between the base and the beverage-holding portion.

47. The device of claim 33, wherein the device further includes a light-directing structure adapted to redirect at least a substantial portion of the emitted light that would otherwise pass through a lower portion of the beverage-holding portion to reduce the amount of emitted light that passes through the lower portion.

48. The device of claim 47, wherein the light-directing structure is adapted to reduce by at least 50% the amount of the emitted light that passes through the lower portion.

49. The device of claim 47, wherein the light-directing structure is adapted to reduce by at least 75% the amount of the emitted light that passes through the lower portion.

50. The device of claim 47, wherein the light-directing structure is adapted to prevent the emitted light from passing through the lower portion.

51. The device of claim 47, wherein the beverage-holding portion includes sides and the light-directing structure includes a lens assembly adapted to focus the emitted light toward the sides of the beverage-holding portion.

52. The device of claim 51, wherein the lens assembly includes a plurality of lens surfaces.

53. The device of claim 51, wherein the light-directing structure further includes a shade through which at least a substantial portion of the emitted light cannot pass.

54. The device of claim 47, wherein the light-directing structure includes a shade through which at least a substantial portion of the emitted light cannot pass.

55. The device of claim 54, wherein the shade includes an opaque region.

56. The device of claim 54, wherein the shade includes a reflective region.

57. The device of claim 33, wherein the body further includes a stem portion extending between the base and the beverage-holding portion.

58. The device of claim 33, wherein the body is a stemless body.

59. The device of claim 33, wherein the beverage-holding portion is at least substantially formed from a light-permeable material.

60. The device of claim 33, wherein the beverage-holding portion is completely formed from a light-permeable material.

61. A beverage-holding device, comprising:
a body having a beverage-holding portion adapted to receive a beverage and having an opening from which a user may drink the beverage, and a base adapted to support the beverage-holding portion on a surface, wherein at least a portion of the body is formed from a light-permeable material; and
means at least partially within the body for illuminating at least a portion of the light-permeable material.

62. The device of claim 61, further including light-deflecting means for receiving light emitted from the means for illuminating at least a portion of the light-permeable material and redirecting at least a substantial portion of the light generally away from a lower portion of the beverage-holding portion.

63. The device of claim 61, further including means for actuating the means for illuminating at least a portion of the light-permeable material.
